(19) United States
(12) Patent Application Publication
(10) Pub. No.: US 2013/0247922 A1
(43) Pub. Date: Sep. 26, 2013

(54) Shock absorbing mouth guard

(71) Applicant: Brian Kamradt, Indianapolis, IN (US)

(72) Inventor: Brian Kamradt, Indianapolis, IN (US)

(21) Appl. No.: 13/506,044

(22) Filed: Mar. 23, 2012

(51) Int. Cl. A61C 5/14

(52) U.S. Cl. 128/862; 128/861

(57) ABSTRACT

This invention is a shock absorbing mouth guard used by athletes to reduce the transfer of impact energy between the upper and lower jaw and thus prevent or greatly reduce injury to the mouth and jaw area. This is accomplished through the utilization of an outer and inner member. The outer member is made of a hard ridged material and acts as a support were as the inner member is made of a soft flexible rubber like material and acts like a shock absorber.

### BACKGROUND OF THE INVENTION

This invention pertains to a shock absorbing mouth guard used by athletes in contact sports and particularly designed to comfortably protect both the upper and lower jaw of the athlete.

Existing mouth guards utilize a relatively hard plastic to protect the tooth-bone during object collisions. The use of hard plastic is well suited for protecting tooth-bone in this matter but does very little to absorb energy associated with a blow.

The drawbacks of using hard plastics are:

1: limited ability to absorb energy. Hard rigid structure lack the ability to absorb energy instead they deflect energy.

2: lack of flexibility. The hard plastics are not flexible and do not conform well to the individuals teeth.

3: uncomfortable. The hard plastics are not comfortable and the discomfort can lead to individuals not wanting to wear them.

Since absorbing of energy from a blow is needed to prevent injury to the upper and lower jaw and the use of flexible rubber like materials will allow for better comfort and conformity to individuals teeth, the hard plastics and their lack of energy absorbing properties and their lack of flexibility and comfort ability are all undesirable results.

Therefore, a need exists for a mouth guard that can absorb the energy from impact, is flexible, and is relatively comfortable.

### BRIEF SUMMARY OF INVENTION

After much research and study into the above mentioned problems the present invention has been developed to provide a shock absorbing mouth guard that is made of a soft rubber like material with shock absorbing abilities designed to protect the upper and lower jaw from injury and to add comfort to the wearer.

The above is accomplished through the provision of an inner member made from a shock absorbing rubber like material that is soft and is held in shape and bonded to an outer support member made of a more ridged material.

### BRIEF DESCRIPTION OF DRAWINGS

FIG. 1 is a perspective view of the mouth guard in accordance with the present invention.

FIG. 2 is an exploded perspective view of the mouth guard in FIG. 1;

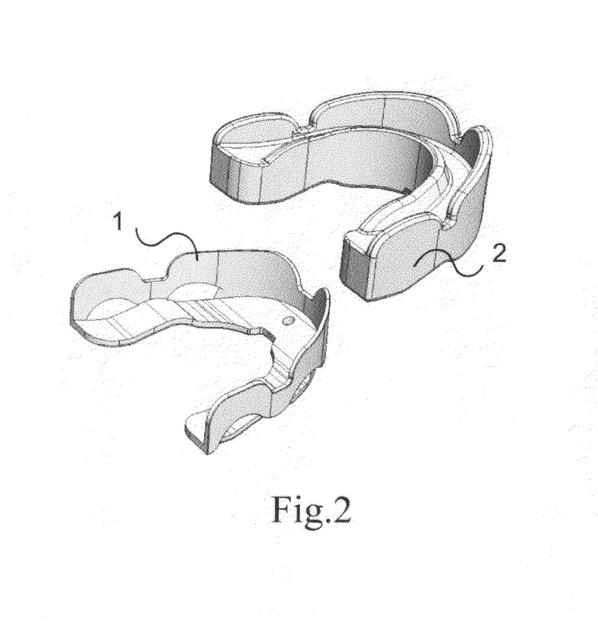

FIG. 3 is a cutaway view of the shock absorbing means shown in FIG. 1;

### DETAILED DESCRIPTION OF INVENTION

This description relates to the general comments herein, as well as the figures referred to in the drawings.

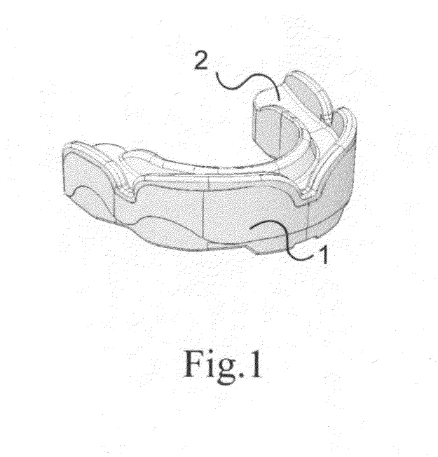

As noted, FIG. 1 is a perspective view of the mouth guard with outer and inner members therein. The outer rigid support member (1). The inner soft flexible rubber like member (2).

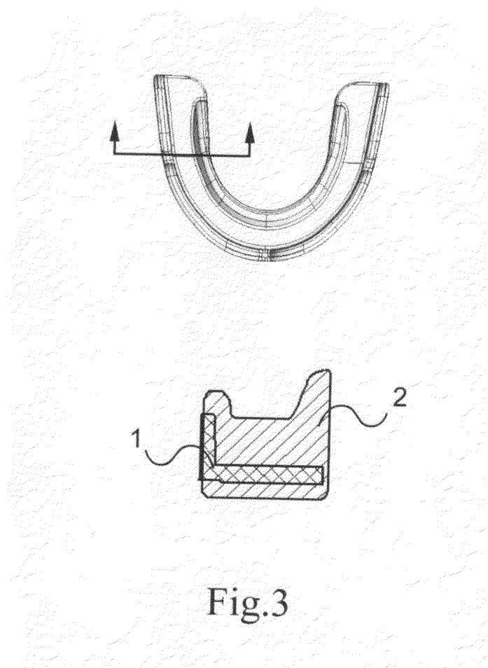

Next, consistent with all of the foregoing, FIG. 3 is a cross-sectional view of the mouth guard, illustrating the shock absorbing structure. The outer rigid support member (1) over-molded with the inner soft rubber like member (2) to provide enhanced shock absorption. As depicted, the structure is pre-formed with the member (1) made of a hard resilient material like polypropylene and the inner member (2) made of a soft rubber like material, each is combined in an over mold process to make a complete structure. The outer ridged support member (1) is utilized to locate and support the inner soft flexible rubber like member (2), also unlike the prior art. As noted, this configuration provides the utmost in impact and energy absorption.

Combined as an assembly it creates a structure for absorbing of energy, thereby reducing the adverse effects of impact in a manner previously unattained.

From the above it can be seen that the present invention provides a multiple staged energy absorbing means which provides superior protection for the athlete or other person wearing the same.

The present invention may, of course, be carried out in other specific ways than those herein set forth without departing from the spirit and essential characteristics of the invention. The present embodiments are, therefore, to be considered in all respects as illustrative and not restrictive and all changes coming within the meaning and equivalency range of the appended claims are intended to be embraced therein.

What is claimed:

1. A mouth guard having the capability to absorb energy of a blow comprising of: an outer ridged member for support and an inner softer rubber like member for absorbing. Combined in an over-mold process they create a shock absorbing structure that can reduce the transfer of impact energy between the upper and lower jaw and thus prevent or greatly reduce injury to the mouth and jaw area.

2. The mouth guard means of claim 1 wherein said outer layer is formed from a hard ridged plastic material.

3. The mouth guard means of claim 2 wherein said hard ridged material is of urethane.

4. The mouth guard means of claim 1 wherein said outer layer is moved inward and is surrounded by the inner layer.

5. The mouth guard means of claim 1 wherein said inner layer is formed from an impact absorbing material

6. The mouth guard means of claim 5 wherein said impact absorbing material is of a thermal plastic elastomer.

7. The mouth guard means of claim 5 wherein said impact absorbing material is of a silicone rubber type.

8. The mouth guard means of claim 1 wherein the mouth guard can be fitted by the user means of the boil and bite procedure.

9. The mouth guard means of claim 1 wherein the mouth guard can be used directly out of the package without means of the boil and bite procedure.

10. The mouth guard means of claim 1 wherein the mouth guard covers the upper teeth.

11. The mouth guard means of claim 1 wherein the mouth guard covers the lower teeth.

12. The mouth guard means of claim 1 wherein the mouth guard covers both upper and lower teeth.
